(19) United States
(12) Patent Application Publication
(10) Pub. No.: US 2024/0013444 A1
(43) Pub. Date: Jan. 11, 2024

(54) POINT CLOUD ENCODING/DECODING METHOD AND APPARATUS BASED ON TWO-DIMENSIONAL REGULARIZED PLANE PROJECTION

(71) Applicant: Honor Device Co., Ltd., Shenzhen (CN)

(72) Inventors: Fuzheng YANG, Shenzhen (CN); Wei ZHANG, Shenzhen (CN); Tian CHEN, Shenzhen (CN); Yuxin DU, Shenzhen (CN); Zexing SUN, Shenzhen (CN); Youguang YU, Shenzhen (CN); Ke ZHANG, Shenzhen (CN); Jiarun SONG, Shenzhen (CN)

(73) Assignee: Honor Device Co., Ltd., Shenzhen (CN)

(21) Appl. No.: 18/036,493

(22) PCT Filed: Feb. 7, 2022
(86) PCT No.: PCT/CN2022/075410

§ 371 Date: May 11, 2023

(30) Foreign Application Priority Data
Feb. 8, 2021 (CN) 202110171969.5

(51) Int. Cl. G06T 9/00

(52) U.S. Cl. CPC G06T 9/001

(57) ABSTRACT

The present application discloses a point cloud encoding/decoding method and apparatus based on two-dimensional regularized plane projection. The encoding method includes: acquiring raw point cloud data; performing two-dimensional regularized plane projection on the raw point cloud data to obtain a two-dimensional projection plane structure; obtaining one or more pieces of two-dimensional graphic information based on the two-dimensional projection plane structure; and encoding the one or more pieces of two-dimensional graphic information to obtain bit stream information. In the present application, a strong correlation representation of a point cloud on a two-dimensional projection plane structure is obtained using a two-dimensional regularized plane projection technology, which highlights spatial correlation of the point cloud.

### CROSS-REFERENCE TO RELATED APPLICATIONS

This application is a national stage of International Application No. PCT/CN2022/075410, filed on Feb. 7, 2022, which claims priority to Chinese Patent Application No. 202110171969.5, filed on Feb. 8, 2021, both of which are incorporated by reference in their entireties.

### TECHNICAL FIELD

The present application pertains to the field of codec technologies, and specifically, to a point cloud encoding/decoding method apparatus based on two-dimensional regularized plane projection.

### BACKGROUND

With the improvement of hardware processing capabilities and the rapid development of computer vision, three-dimensional point clouds have been a new generation of immersive multimedia following audio, image, and video, and are widely used in virtual reality, augmented reality, autonomous driving, environmental modeling, and the like. However, a three-dimensional point cloud generally has a large amount of data, which hinders transmission and storage of point cloud data. Therefore, research on an efficient point cloud encoding and decoding technology is of great significance.

In an existing geometry-based point cloud compression coding (G-PCC, Geometry-based Point Cloud Compression) framework, geometric information and attribute information of a point cloud are encoded separately. At present, geometric codec of G-PCC can be classified into octree-based geometric codec and prediction tree-based geometric codec.

For octree-based geometric codec: geometric information of a point cloud is first preprocessed at the encoding end. This involves coordinate conversion and voxelization of the point cloud. Then, tree division (octree/quadtree/binary tree) is performed constantly in order of breadth-first search on a bounding box where the point cloud is located. Finally, a placeholder code of each node is encoded and the number of points contained in each leaf node is encoded to generate a binary bit stream. At the decoding end, constant parsing is first performed in order of breadth-first search to obtain the placeholder code of each node. Then, tree division is performed constantly and sequentially until a unit cube of 1×1×1 is obtained. Finally, the number of points contained in each leaf node is obtained by parsing, and reconstructed geometric information of the point cloud is obtained.

For prediction tree-based geometric codec: sorting is performed on an input point cloud at the encoding end. Then, a prediction tree structure is established. Each point is classified to a laser scanner it belongs to, and the prediction tree structure is established based on different laser scanners. Next, each node in the prediction tree is traversed. Different prediction modes are selected to predict geometric information of a node to obtain a prediction residual, and a quantization parameter is used to quantify the prediction residual. Finally, the prediction tree structure, the quantization parameter, the prediction residual of the geometry information of the node, and the like are encoded to generate a binary bit stream. At the decoding end, the bit stream is parsed, and the prediction tree structure is reconstructed. Then, the prediction residual is dequantized using geometric information prediction residual of each node obtained by parsing and the quantization parameter. Finally, reconstructed geometric information of each node is retrieved. In this way, the geometric information of the point cloud is reconstructed.

However, a point cloud has a high spatial sparsity. Therefore, for a point cloud encoding technology using an octree structure, empty nodes obtained by division takes up a high proportion, and spatial correlation of the point cloud cannot be fully reflected. This hinders prediction and entropy coding of the point cloud. For the point cloud codec technology based on the prediction tree, some parameters of a laser radar device are used to establish a tree structure. On this basis, the tree structure is used for predictive coding, but this tree structure does not fully reflect the spatial correlation of a point cloud and therefore hinders prediction and entropy coding of the point cloud. As a result, both the foregoing two point cloud codec technologies have a problem of low encoding efficiency.

### SUMMARY

To solve the foregoing problem, the present application provides a point cloud encoding/decoding method and apparatus based on two-dimensional regularized plane projection. In the present application, the technical problem is solved by using the following technical solution:

A point cloud encoding method based on two-dimensional regularized plane projection, including:
acquiring raw point cloud data;
performing two-dimensional regularized plane projection on the raw point cloud data to obtain a two-dimensional projection plane structure;
obtaining one or more pieces of two-dimensional graphic information based on the two-dimensional projection plane structure; and
encoding the one or more pieces of two-dimensional graphic information to obtain bit stream information.

In an embodiment of the present application, the one or more pieces of two-dimensional graphic information includes a coordinate conversion error information graph.

In an embodiment of the present application, the encoding the one or more pieces of two-dimensional graphic information to obtain bit stream information includes: encoding the coordinate conversion error information graph to obtain a coordinate conversion error information bit stream.

In an embodiment of the present application, the encoding the coordinate conversion error information graph to obtain a coordinate conversion error information bit stream includes:
predicting pixels in the coordinate conversion error information graph based on a placeholder information graph, a depth information graph, and a projection residual information graph to obtain a prediction residual of a coordinate conversion error; or
predicting pixels in the coordinate conversion error information graph based on reconstructed coordinate conversion error information of encoded and decoded pixels to obtain a prediction residual of a coordinate conversion error; and
encoding the prediction residual of the coordinate conversion error to obtain the coordinate conversion error information bit stream.

In an embodiment of the present application, the predicting pixels in the coordinate conversion error information graph based on a placeholder information graph, a depth information graph, and a projection residual information graph to obtain a prediction residual of a coordinate conversion error includes:
traversing the pixels in the coordinate conversion error information graph according to a specified scanning order, and identifying encoded and decoded non-empty pixels in an area adjacent to a current non-empty pixel based on the placeholder information graph;
establishing a relationship between depth information and coordinate conversion error information by using the encoded and decoded non-empty pixels, and establishing a relationship between projection residual information and coordinate conversion error information by using the encoded and decoded non-empty pixels;
estimating coordinate conversion error information corresponding to a current pixel based on the relationship between depth information and coordinate conversion error information and the relationship between projection residual information and coordinate conversion error information, to obtain an estimated value of the coordinate conversion error of the current pixel; and
using the estimated value as a predicted value of the coordinate conversion error of the current pixel to obtain a prediction residual of the coordinate conversion error of the current pixel.

In an embodiment of the present application, the encoding the coordinate conversion error information graph to obtain a coordinate conversion error information bit stream further includes:
predicting pixels in the coordinate conversion error information graph based on part of information graphs among a placeholder information graph, a depth information graph, and a projection residual information graph to obtain a prediction residual of a coordinate conversion error; and
encoding the prediction residual of the coordinate conversion error to obtain the coordinate conversion error information bit stream.

Another embodiment of the present application further provides a point cloud encoding apparatus based on two-dimensional regularized plane projection. The apparatus includes:
a first data acquisition module, configured to acquire raw point cloud data;
a projection module, configured to perform two-dimensional regularized plane projection on the raw point cloud data to obtain a two-dimensional projection plane structure;
a data processing module, configured to obtain one or more pieces of two-dimensional graphic information based on the two-dimensional projection plane structure; and
an encoding module, configured to encode the one or more pieces of two-dimensional graphic information to obtain bit stream information.

Still another embodiment of the present application further provides a point cloud decoding method based on two-dimensional regularized plane projection. The method includes:
acquiring and decoding bit stream information to obtain parsed data;
reconstructing one or more pieces of two-dimensional graphic information based on the parsed data;
obtaining a two-dimensional projection plane structure based on the one or more pieces of two-dimensional graphic information; and
reconstructing a point cloud by using the two-dimensional projection plane structure.

In an embodiment of the present application, the reconstructing one or more pieces of two-dimensional graphic information based on the parsed data includes:
reconstructing a coordinate conversion error information graph based on a prediction residual of the coordinate conversion error information graph in the parsed data to obtain a reconstructed coordinate conversion error information graph.

Still yet another embodiment of the present application further provides a point cloud decoding apparatus based on two-dimensional regularized plane projection. The apparatus includes:
a second data acquisition module, configured to acquire and decode bit stream information to obtain parsed data;
a first reconstruction module, configured to reconstruct one or more pieces of two-dimensional graphic information based on the parsed data;
a second reconstruction module, configured to obtain a two-dimensional projection plane structure based on the one or more pieces of two-dimensional graphic information; and
a point cloud reconstruction module, configured to reconstruct a point cloud by using the two-dimensional projection plane structure.

Beneficial effects of the present application are as follows:

1. In the present application, a point cloud in a three-dimension space is projected into a corresponding two-dimensional regularized projection plane structure, and the point cloud is corrected through regularization in a vertical direction and a horizontal direction. In this way, a strong correlation representation of the point cloud on the two-dimensional projection plane structure is obtained. This avoids sparsity in a three-dimensional representation structure and highlights spatial correlation of the point cloud. During subsequent encoding of a coordinate conversion error information graph obtained from the two-dimensional regularized projection plane structure, the spatial correlation of the point cloud can be fully utilized to reduce spatial redundancy. This further improves the encoding efficiency of the point cloud.

2. In the present application, predictive coding is performed on a coordinate conversion error information graph by using a placeholder information graph, a depth information graph, and a projection residual information graph. This improves the encoding efficiency.

The following further describes the present application in detail with reference to the accompanying drawings and embodiments.

### BRIEF DESCRIPTION OF DRAWINGS

FIG. 1 is a schematic diagram of a point cloud encoding method based on two-dimensional regularized plane projection according to an embodiment of the present application;

FIG. 2 is a schematic diagram of a mapping between cylindrical coordinates of a point and a pixel in a two-dimensional projection plane according to an embodiment of the present application;

FIG. 3 is a schematic diagram of a two-dimensional projection plane structure of a point cloud according to an embodiment of the present application;

FIG. 4 is a block diagram of encoding a coordinate conversion error information graph according to an embodiment of the present application;

FIG. 5 is a schematic diagram of predicting a coordinate conversion error according to an embodiment of the present application;

FIG. 6 is a flowchart of entropy coding of a prediction residual of a coordinate conversion error according to an embodiment of the present application;

FIG. 7 is a schematic structural diagram of a point cloud encoding apparatus based on two-dimensional regularized plane projection according to an embodiment of the present application;

FIG. 8 is a schematic diagram of a point cloud decoding method based on two-dimensional regularized plane projection according to an embodiment of the present application;

FIG. 9 is a block diagram of decoding a coordinate conversion error information graph according to an embodiment of the present application; and

FIG. 10 is a schematic structural diagram of a point cloud decoding apparatus based on two-dimensional regularized plane projection according to an embodiment of the present application.

### DESCRIPTION OF EMBODIMENTS

The following further describes the present application in detail with reference to specific embodiments, but the embodiments of the present application are not limited hereto.

### Embodiment 1

Refer to FIG. 1. FIG. 1 is a schematic diagram of a point cloud encoding method based on two-dimensional regularized plane projection according to an embodiment of the present application. The method includes the following steps.

S1. Acquire Raw Point Cloud Data.

Specifically, the raw point cloud data generally includes a set of three-dimensional spatial points, and each spatial point records its own geometric position information, as well as additional attribute information such as color, reflectivity, and normal line. The geometric position information of a point cloud is generally represented using the Cartesian coordinate system, namely, X, Y, and Z coordinates of points. The raw point cloud data may be obtained by using a 3D scanning device such as a laser radar, and may also be obtained from common datasets provided by various platforms. In this embodiment, the geometric position information of the acquired raw point cloud data is represented based on the Cartesian coordinate system. It should be noted that a representation method of the geometric position information of the raw point cloud data is not limited to Cartesian coordinates.

S2. Perform Two-Dimensional Regularized Plane Projection on the Raw Point Cloud Data to Obtain a Two-Dimensional Projection Plane Structure.

Specifically, in this embodiment, before two-dimensional regularized plane projection is performed on a raw point cloud, preprocessing may also be performed on the raw point cloud data, for example, voxelization processing, to facilitate subsequent encoding.

First, the two-dimensional projection plane structure is initialized.

Regularization parameters need to be used in initializing the two-dimensional regularized projection plane structure of a point cloud. Generally, the regularization parameters are finely measured by the manufacturer and provided for consumers as one of necessary data, for example, an acquisition range of a laser radar, sampled angular resolution Δφ or number of sampled points for horizontal azimuth, as well as a distance correction factor of each laser scanner, information on offsets of a laser scanner along the vertical and horizontal directions Vₒ and Hₒ, and information on offsets of a laser scanner along the pitch angle and horizontal azimuth angle θ₀, and α.

It should be noted that the regularization parameters are not limited to the above-mentioned parameters, which may be given calibration parameters of the laser radar, or may be obtained by such means as estimation optimization and data fitting if the calibration parameters of the laser radar are not given.

The two-dimensional regularized projection plane structure of a point cloud is a data structure containing M rows of and N columns of pixels. After projection, points in a three-dimensional point cloud correspond to pixels in the data structure. In addition, a pixel (i, j) in the data structure can be associated with a cylindrical coordinate component (θ, ϕ). For example, a pixel (i, j) corresponding to cylindrical coordinates (r, θ, ϕ) can be found using the following formula:

$$i = {min}_{1 , 2 … LaserNum} \vert θ - {θ}_{0} \vert ;$$

$$j = ( ϕ + 180 ° ) / Δφ .$$

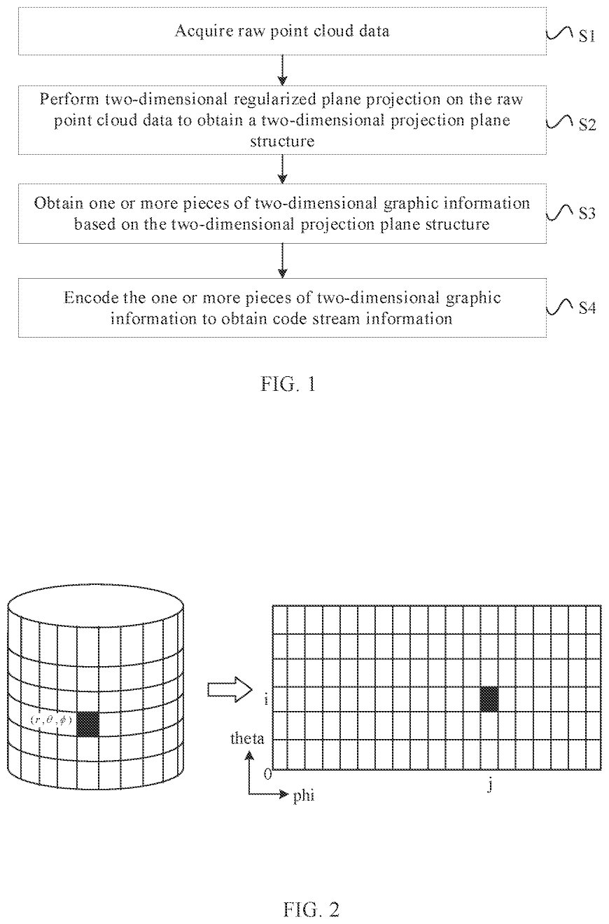

Specifically, refer to FIG. 2. FIG. 2 is a schematic diagram of a mapping between cylindrical coordinates of a point and a pixel in a two-dimensional projection plane according to an embodiment of the present application.

It should be noted that such a mapping is not limited to the mapping between pixels and cylindrical coordinates.

Further, resolution of the two-dimensional regularized projection plane may be obtained from the regularization parameters. For example, if the resolution of the two-dimensional regularized projection plane is M×N, the number of laser scanners in the regularization parameters can be used to initialize M, and the sampled angular resolution for horizontal azimuth Δ_{φ} (or the number of sampled points of the laser scanner) is used to initialize N. For example, the following formula can be used to eventually initialize the two-dimensional projection plane structure and obtain a plane structure containing M×N pixels.

$$M = laserNum ;$$

$$N = \frac{360 °}{Δφ} or N = pointNumPerLaser .$$

Second, the mapping between the raw point cloud data and the two-dimensional projection plane structure is determined, so as to project the raw point cloud data onto the two-dimensional projection plane structure.

In this part, a position of the raw point cloud in the two-dimensional projection plane structure is determined point by point, so as to map originally discretely distributed point clouds in the Cartesian coordinate system to the uniformly distributed two-dimensional regularized projection plane structure. Specifically, a corresponding pixel is determined in the two-dimensional projection plane structure for each point in the raw point cloud. For example, a pixel with the smallest spatial distance from the projected position of a point in the two-dimensional plane can be selected as a corresponding pixel of the point.

If two-dimensional projection is performed in the cylindrical coordinate system, a specific process of determining pixels corresponding to a raw point cloud is as follows.

a. Determine a cylindrical coordinate component r of a current point in the raw point cloud data. Specifically, calculation is performed using the following formula:

r=\sqrt{x₂+y²}

b. Determine a search area for the current point in the two-dimensional projection plane structure. Specifically, the entire two-dimensional projection plane structure may be directly selected as the search area. Further, to reduce the amount of computation, the search area for the corresponding pixel in the two-dimensional projection plane structure may also be determined based on cylindrical coordinate components of a pitch angle θ and an azimuth angle ϕ of the current point, so as to reduce the search area.

c. After the search area is determined, for each pixel (i, j) therein, calculate a position (x1, y1, z1) of a current pixel in the Cartesian coordinate system by using the regularization parameters, namely, calibration parameters of the i-th laser scanner of the laser radar θ₀, Vₒ, Hₒ, and α. The specific calculation formulas are as follows:

θᵢ=θ₀

ϕⱼ=−180°+j×Δφ

x1=r·sin(ϕⱼ−α)−Hₒ·cos(ϕⱼ−α)

y1=r·cos(ϕⱼ−α)+Hₒ·sin(ϕⱼ−α)

z1=r·tan θᵢ+Vₒ

d. After the position (x1, y1, z1) of the current pixel in the Cartesian coordinate system is obtained, calculate a spatial distance between the current pixel and the current point (x, y, z) and use it as an error Err, namely:

Err=dist{(x,y,z),(x1,y1,z1)}

If the error Err is smaller than a current minimum error minErr, the error Err is used to update the minimum error minErr, and i and j corresponding to the current pixel are used to update i and j of a pixel corresponding to the current point. If the error Err is greater than the minimum error minErr, the foregoing update process is not performed.

e. When all pixels in the search area are traversed, the corresponding pixel (i, j) of the current point in the two-dimensional projection plane structure can be determined.

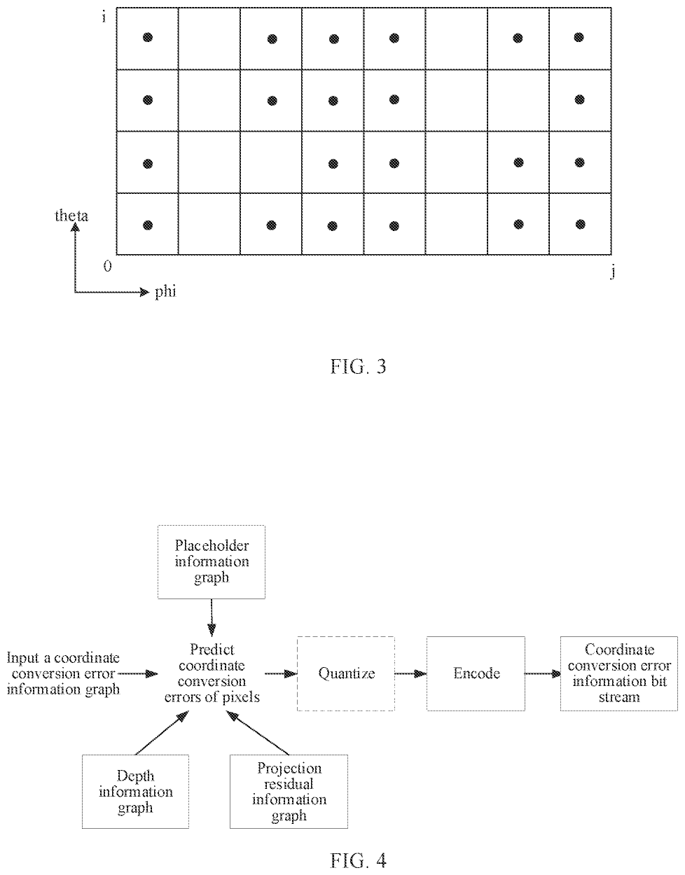

When the foregoing operations are completed on all points in the raw point cloud, the two-dimensional regularized plane projection of the point cloud is completed. Specifically, refer to FIG. 3. FIG. 3 is a schematic diagram of a two-dimensional projection plane structure of a point cloud according to an embodiment of the present application, where each point in the raw point cloud data is mapped to a corresponding pixel in this structure.

It should be noted that during the two-dimensional regularized plane projection of a point cloud, a plurality of points in the point cloud may correspond to a same pixel in the two-dimensional projection plane structure. To avoid this situation, these spatial points can be projected to different pixels during projection. For example, during projection of a specified point, if its corresponding pixel already corresponds to a point, the specified point is projected to an empty pixel adjacent to the pixel. In addition, if a plurality of points in a point cloud have been projected to a same pixel in the two-dimensional projection plane structure, during encoding based on the two-dimensional projection plane structure, the number of corresponding points in each pixel should also be encoded and information on each of the corresponding points in the pixel should be encoded based on the number of corresponding points.

S3. Obtain One or More Pieces of Two-Dimensional Graphic Information Based on the Two-Dimensional Projection Plane Structure.

In this embodiment, the one or more pieces of two-dimensional graphic information includes a coordinate conversion error information graph.

Specifically, the coordinate conversion error information graph is used to represent a residual between a spatial position obtained by back projection of each occupied pixel in the two-dimensional regularized projection plane structure and a spatial position of a raw point corresponding to the pixel.

For example, the following method can be used to calculate a coordinate conversion error of a pixel. Assuming that the current pixel is (i, j) and Cartesian coordinates of its corresponding point is (x, y, z), regularization parameters and the following formula can be used to convert the pixel back to the Cartesian coordinate system and obtain the corresponding Cartesian coordinates (x1, y1, z1).

θᵢ=θ₀

r=\sqrt{x²+y²}

x1=r·sin(ϕⱼ−α)−Hₒ·cos(ϕⱼ−α)

y1=r·cos(ϕⱼ−α)+Hₒ·sin(ϕⱼ−α)

z1=r·tan θᵢ+Vₒ

Next, the coordinate conversion error (Δx, Δy, Δz) of the current pixel can be calculated using the following formula:

Δx=x−x1

Δy=y−y1

Δz=z−z1

According to the foregoing calculations, each occupied pixel in the two-dimensional regularized projection plane structure has a coordinate conversion error, and therefore a coordinate conversion error information graph corresponding to the point cloud is obtained.

S4. Encode the One or More Pieces of Two-Dimensional Graphic Information to Obtain Bit Stream Information.

Accordingly, the encoding the one or more pieces of two-dimensional graphic information to obtain bit stream information includes: encoding the coordinate conversion error information graph to obtain a coordinate conversion error information bit stream. Specifically, the coordinate conversion error information graph needs to be predicted to obtain a prediction residual of the coordinate conversion error information, and then the prediction residual is encoded.

In this embodiment, pixels in the coordinate conversion error information graph may be predicted based on a placeholder information graph, a depth information graph, a projection residual information graph, and reconstructed coordinate conversion error information of encoded and decoded pixels to obtain a prediction residual.

The placeholder information graph is used to identify whether a pixel in the two-dimensional regularized projection plane structure is occupied, that is, whether each pixel corresponds to a point in the point cloud. If occupied, the pixel is non-empty; otherwise, the pixel is empty. Therefore, the placeholder information graph can be obtained based on the two-dimensional projection plane structure of the point cloud.

The depth information graph is used to represent distance between the corresponding point of each occupied pixel in the two-dimensional regularized projection plane structure and the coordinate origin. For example, the cylindrical coordinate component r of the corresponding point of the pixel can be used as depth of the pixel. Based on this, each occupied pixel in the two-dimensional regularized projection plane structure has a depth value, and therefore the depth information graph is obtained.

The projection residual information graph is used to represent a residual between a corresponding position and an actual projection position of each occupied pixel in the two-dimensional regularized projection plane structure. Based on this, each occupied pixel in the two-dimensional regularized projection plane structure has a projection residual, and therefore the projection residual information graph is obtained.

The placeholder information graph, the depth information graph, and the projection residual information graph can all be directly obtained from the two-dimensional regularized projection plane structure.

Refer to FIG. 4. FIG. 4 is a block diagram of encoding a coordinate conversion error information graph according to an embodiment of the present application, which specifically includes the following.

41) Predict the Coordinate Conversion Error of a Pixel.

In this embodiment, the coordinate conversion error of the current pixel can be predicted based on the placeholder information graph, the depth information graph, the projection residual information graph, and the reconstructed coordinate conversion error information of encoded and decoded pixels. Details are as follows.

41a) Traverse Each Pixel in the Coordinate Conversion Error Information Graph according to a specified scanning order, and identify encoded and decoded non-empty pixels in an area adjacent to a current non-empty pixel based on the placeholder information graph.

For example, in this embodiment, each pixel in the coordinate conversion error information graph may be traversed by using a Z-scan method.

41b) Establish a relationship between depth information and reconstructed coordinate conversion error information by using the encoded and decoded non-empty pixels, and establish a relationship between projection residual information and the reconstructed coordinate conversion error information by using the encoded and decoded non-empty pixels.

For example, a simple relationship can be established to select a reference pixel, from the encoded and decoded non-empty pixels in the adjacent area of the current non-empty pixel, which is close to the current pixel in terms of depth information and projection residual information.

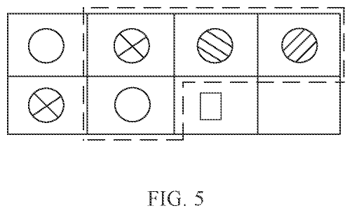

Specifically, refer to FIG. 5. FIG. 5 is a schematic diagram of predicting a coordinate conversion error according to an embodiment of the present application. [symbol] represents the current pixel, [symbol] represents the reference pixel in the adjacent area, [symbol] represents an adjacent-area pixel that differs greatly from the current pixel in the depth information, [symbol] represents an adjacent-area pixel that differs greatly from the current pixel in the projection residual information, and [symbol] represents an empty pixel that has been encoded and decoded and not been occupied.

During prediction of the coordinate conversion error of the current pixel, the placeholder information graph is used to determine occupancy status of encoded and decoded pixels in an area adjacent to the current pixel, that is, within the dashed-line box, non-empty pixels in the area are identified, and then these encoded and decoded non-empty pixels can be used to simply establish a relationship between the depth information and a reconstructed coordinate conversion error. For example, the following relationship may be established: if two pixels have similar depth information, their coordinate conversion errors are similar. Likewise, these encoded and decoded non-empty pixels may also be used to simply establish a relationship between the projection residual information and the reconstructed coordinate conversion error. For example, the following relationship may be established: if two pixels have similar projection residual, their coordinate conversion errors are similar. In this case, pixels that are similar to the current pixel in terms of the depth information and the projection residual information can be selected, from these encoded and decoded non-empty pixels, as the reference pixels, and an average of reconstructed coordinate conversion error information of these reference pixels is calculated and used as a predicted value (Δx_pred, Δy_pred, Δz_pred) of the coordinate conversion error information of the current pixel. The specific calculation formulas are as follows:

$$Δx\_pred = {\sum }_{i = 1}^{N} Δ {x}_{i} / N$$

$$Δy\_pred = {\sum }_{i = 1}^{N} Δ {y}_{i} / N$$

$$Δz\_pred = {\sum }_{i = 1}^{N} Δ {z}_{i} / N$$

(Δxᵢ, Δyᵢ, Δzᵢ), i=1, 2 . . . N are the reconstructed coordinate conversion errors of the adjacent reference pixels of the current pixel, and N is the number of the reference pixels in the adjacent area. After the predicted value of the coordinate conversion error of the current pixel is obtained, a difference between an original coordinate conversion error and the predicted coordinate conversion error of the current pixel is calculated, that is, obtaining a prediction residual of the coordinate conversion error of the current pixel.

In this embodiment, pixels in the coordinate conversion error information graph may also be predicted based on part of information graphs among the placeholder information graph, the depth information graph, and the projection residual information graph to obtain a prediction residual of a coordinate conversion error. The detailed process is not described herein.

In the present application, during encoding of the coordinate conversion error information, prediction is performed on the coordinate conversion error information graph by using the placeholder information graph, the depth information graph, and the projection residual information graph. This improves the encoding efficiency.

In another embodiment of the present application, a conventional encoding method may be used: predicting pixels in the coordinate conversion error information graph directly based on reconstructed coordinate conversion error information of encoded and decoded pixels to obtain the prediction residual.

In addition, a rate-distortion optimization model may also be used to select an optimal prediction mode from a number of preset prediction modes for predicting the pixels in the coordinate conversion error information graph, to obtain the prediction residual.

For example, the following six prediction modes may be set.
Mode 0: direct mode, performing direct compression without prediction;
Mode 1: leftward prediction, using non-empty pixels on the left side as the reference pixels;
Mode 2: upward prediction, using non-empty pixels on the upward side as the reference pixels;
Mode 3: upper-left prediction, using non-empty pixels on the upper left side as the reference pixels;
Mode 4: upper-right prediction, using non-empty pixels on the upper right side as the reference pixels; and
Mode 5: using non-empty pixels on the left side, upward side, upper left side, and upper right side as the reference pixels.

The rate-distortion optimization model is used to select an optimal mode for prediction to obtain the prediction residual.

42) Encode the Prediction Residual to Obtain the Coordinate Conversion Error Information Bit Stream.

After the coordinate conversion error information is predicted, the prediction residual needs to be encoded. It should be noted that lossy encoding of the coordinate conversion information graph requires the prediction residual of the coordinate conversion error information to be quantized before being encoded. Lossless encoding of the coordinate conversion information graph does not require quantization of the prediction residual.

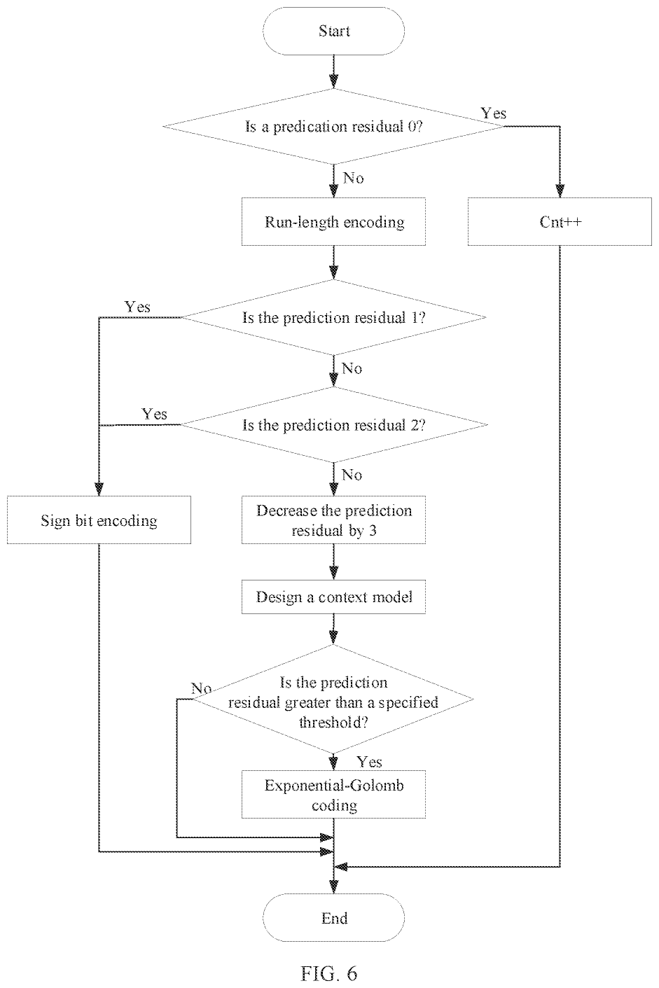

Specifically, in this embodiment, a context-based entropy coding method is used for implementation. For example, the entropy coding process illustrated in FIG. 6 can be used to encode the prediction residual, where Cnt represents the number of consecutive prediction residual components that are zero. The detailed encoding process is as follows:
a. First determine whether the prediction residual of the coordinate conversion error of the current pixel is 0. If it is 0, Cnt is increased by 1 and no encoding is performed subsequently.
b. Otherwise, encode Cnt and determine whether the prediction residual of the coordinate conversion error of the current pixel is 1. If it is 1, the identifier 1 is encoded and no encoding is performed subsequently.
c. Otherwise, determine whether the prediction residual of the coordinate conversion error of the current pixel is 2. If it is 2, the identifier 2 is encoded and no encoding is performed subsequently.
d. Otherwise, decrease the prediction residual of the coordinate conversion error of the current pixel by 3 and determine whether the prediction residual is greater than a specified threshold. If it is smaller than the specified threshold, a context model is designed for the prediction residual; otherwise, encoding is performed in the following manner:
designing a context for encoding prediction residual information smaller than the threshold; and
performing exponential-Golomb coding on prediction residual information greater than the threshold.

In addition, in another embodiment of the present application, the coordinate conversion error information graph may also be encoded by image\video compression. The applicable encoding schemes herein include but are not limited to JPEG, JPEG2000, HEIF, H.264\AVC, and H.265\HEVC.

In another embodiment of the present application, encoding may be performed on other information graphs obtained based on the two-dimensional projection plane structure, such as the placeholder information graph, the depth information graph, the projection residual information graph, and an attribute information graph, to obtain corresponding bit stream information.

In the present application, a point cloud in a three-dimension space is projected into a corresponding two-dimensional regularized projection plane structure, and the point cloud is corrected through regularization in a vertical direction and a horizontal direction. In this way, a strong correlation representation of the point cloud on the two-dimensional projection plane structure is obtained. This avoids sparsity in a three-dimensional representation structure and highlights spatial correlation of the point cloud. During subsequent encoding of a coordinate conversion error information graph obtained from the two-dimensional regularized projection plane structure, the spatial correlation of the point cloud can be fully utilized to reduce spatial redundancy. This further improves the encoding efficiency of the point cloud.

### Embodiment 2

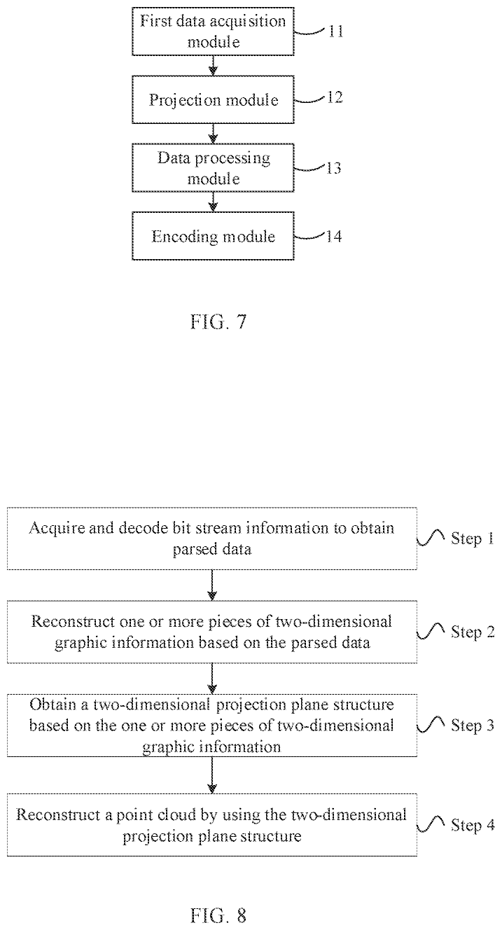

On the basis of embodiment 1, this embodiment provides a point cloud encoding apparatus based on two-dimensional regularized plane projection. Refer to FIG. 7. FIG. 7 is a schematic structural diagram of a point cloud encoding apparatus based on two-dimensional regularized plane projection according to an embodiment of the present application. The apparatus includes:
a first data acquisition module 11, configured to acquire raw point cloud data;
a projection module 12, configured to perform two-dimensional regularized plane projection on the raw point cloud data to obtain a two-dimensional projection plane structure;
a data processing module 13, configured to obtain one or more pieces of two-dimensional graphic information based on the two-dimensional projection plane structure; and
an encoding module 14, configured to encode the one or more pieces of two-dimensional graphic information to obtain bit stream information.

The encoding apparatus provided in this embodiment can implement the encoding method described in embodiment 1. The detailed process is not described herein again.

### Embodiment 3

Refer to FIG. 8. FIG. 8 is a schematic diagram of a point cloud decoding method based on two-dimensional regularized plane projection according to an embodiment of the present application. The method includes the following steps.

S1. Acquire and Decode Bit Stream Information to Obtain Parsed Data.

A decoding end acquires compressed bit stream information, and uses a corresponding existing entropy decoding technology to decode the bit stream information accordingly to obtain the parsed data.

The detailed decoding process is as follows:
a. Parse whether Cnt is greater than or equal to 1. If Cnt is greater than or equal to 1, a prediction residual of a current pixel is 0, and no decoding is performed subsequently. Cnt represents the number of consecutive prediction residuals that are zero.
b. Otherwise, parse whether the prediction residual information of the coordinate conversion error of the current pixel is 1. If it is 1, the prediction residual of the current pixel is 1 and no decoding is performed subsequently.
c. Otherwise, parse whether the prediction residual information of the coordinate conversion error of the current pixel is 2. If it is 2, the prediction residual of the current pixel is 2 and no decoding is performed subsequently.
d. Otherwise, design a corresponding context model for the prediction residual of the coordinate conversion error of the current pixel for decoding, and then determine whether the prediction residual obtained by parsing is greater than a specified threshold. If it is smaller than the specified threshold, no decoding is performed subsequently; otherwise, exponential Golomb decoding is used to decode the prediction residual value greater than the threshold. Finally, the prediction residual value is increased by 3 and used as a final prediction residual of the coordinate conversion error information obtained by parsing.

It should be noted that if the encoding end has quantized the prediction residual of the coordinate conversion error information, the prediction residual obtained by parsing needs to be dequantized herein.

S2. Reconstruct one or more pieces of two-dimensional graphic information based on the parsed data.

In this embodiment, step 2 may include:
reconstructing a coordinate conversion error information graph based on prediction residual of the coordinate conversion error information graph in the parsed data to obtain a reconstructed coordinate conversion error information graph.

Specifically, at the encoding end, the one or more pieces of two-dimensional graphic information may include the coordinate conversion error information graph, meaning that the coordinate conversion error information graph has been encoded. Correspondingly, bit stream information at the decoding end also includes a coordinate conversion error information bit stream. More specifically, the parsed data obtained by decoding the bit stream information includes the prediction residual of the coordinate conversion error information.

In embodiment 1, at the encoding end, the pixels in the coordinate conversion error information graph are traversed according to a specified scanning order and the coordinate conversion error information of the non-empty pixels therein is encoded. Therefore, the prediction residual of the coordinate conversion error information of the pixels obtained by the decoding end also follows this order, and the decoding end can obtain resolution of the coordinate conversion error information graph by using regularization parameters. For details, refer to S2 of embodiment 1, in which the two-dimensional projection plane structure is initialized. Therefore, the decoding end can obtain a position of a current to-be-reconstructed pixel in the two-dimensional graph based on the resolution of the coordinate conversion error information graph and the placeholder information graph.

Specifically, refer to FIG. 9. FIG. 9 is a block diagram of decoding a coordinate conversion error information graph according to an embodiment of the present application. Coordinate conversion error information of the current to-be-reconstructed pixel is predicted based on the placeholder information graph, a depth information graph, a projection residual information graph, and reconstructed coordinate conversion error information of encoded and decoded pixels. This is the same as the prediction method used at the encoding end. The placeholder information graph is used to determine occupancy status of encoded and decoded pixels in an area adjacent to the current to-be-reconstructed pixel, that is, within the dashed-line box, and then non-empty pixels in the area are identified. Next, the relationship, which is established by the encoding end, between the depth information and reconstructed coordinate conversion error information of these encoded and decoded non-empty pixels is used: if two pixels have similar depth information, their coordinate conversion errors are similar. In addition, the relationship, which is established by the encoding end, between the projection residual information and the reconstructed coordinate conversion error is also used: if two pixels have similar projection residual information, their coordinate conversion errors are similar. In this case, pixels that are similar to the current pixel in terms of depth information and projection residual information can be selected, from these encoded and decoded non-empty pixels, as the reference pixels, and an average of reconstructed coordinate conversion error information of these reference pixels is calculated and used as a predicted value of the coordinate conversion error information of the current pixel. Then, the coordinate conversion error information of the current pixel is reconstructed based on the predicted value obtained and the prediction residual obtained by parsing. When coordinate conversion errors of all pixels are reconstructed, a reconstructed coordinate conversion error information graph is obtained.

S3. Obtain a two-dimensional projection plane structure based on the two-dimensional graphic information.

Resolution of the two-dimensional projection plane structure is consistent with the coordinate conversion error information graph, and the coordinate conversion error information graph has been reconstructed. Therefore, the coordinate conversion error information of each non-empty pixel in the two-dimensional projection plane structure can be obtained, so that a reconstructed two-dimensional projection plane structure can be obtained.

S4. Reconstruct a point cloud by using the two-dimensional projection plane structure.

Pixels in the reconstructed two-dimensional projection plane structure are traversed according to a specified scanning order, so that the coordinate conversion error information of each non-empty pixel can be obtained. If the current pixel (i, j) is non-empty and its coordinate conversion error is (Δx, Δy, Δz), other information such as depth information is used to reconstruct a spatial point (x, y, z) corresponding to the pixel. Specifically, a position corresponding to the current pixel (i, j) may be represented as (ϕⱼ, i). Regularization parameters and other information such as the depth information r can be used to reconstruct the spatial point (x, y, z) corresponding to the current pixel. Specific calculations are as follows:

ϕⱼ=−180°+j×Δφ

θᵢ=θ₀

x1=r·sin(ϕⱼ−α)−Hₒ·cos(ϕⱼ−α)

y1=r·cos(ϕⱼ−α)+Hₒ·sin(ϕⱼ−α)

z1=r·tan θᵢ+Vₒ

(x,y,z)=(x1,y1,z1)+(Δx,Δy,Δz)

Finally, a corresponding spatial point can be reconstructed for each non-empty pixel in the two-dimensional projection structure based on the foregoing calculations, so as to obtain a reconstructed point cloud.

### Embodiment 4

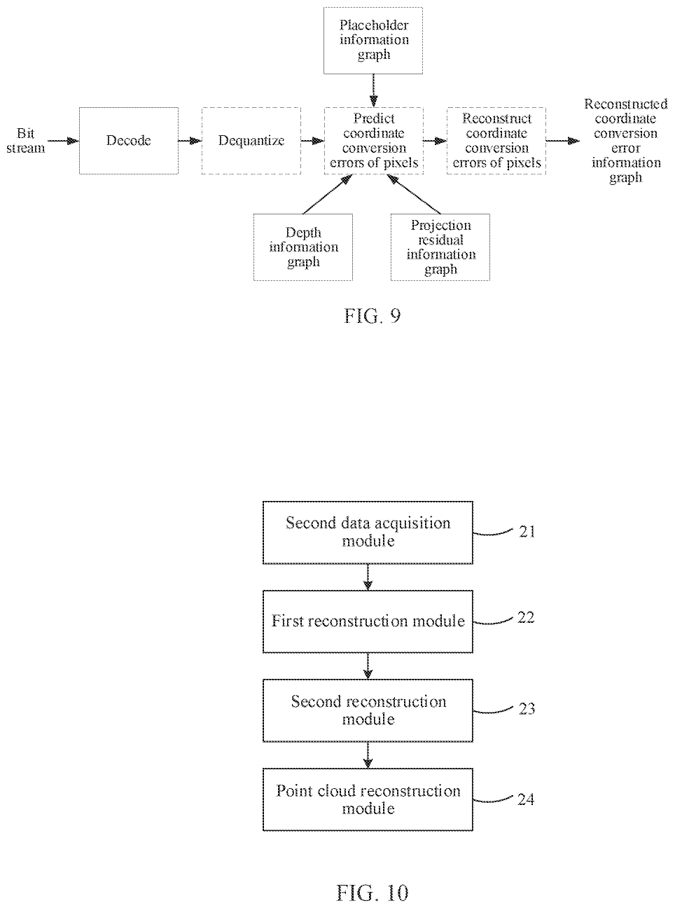

On a basis of the foregoing embodiment 3, this embodiment provides a point cloud decoding apparatus based on two-dimensional regularized plane projection. Refer to FIG. 10. FIG. 10 is a schematic structural diagram of a point cloud decoding apparatus based on two-dimensional regularized plane projection according to an embodiment of the present application. The apparatus includes:
a second data acquisition module 21, configured to acquire and decode bit stream information to obtain parsed data;
a first reconstruction module 22, configured to reconstruct one or more pieces of two-dimensional graphic information based on the parsed data;
a second reconstruction module 23, configured to obtain a two-dimensional projection plane structure based on the one or more pieces of two-dimensional graphic information; and a point cloud reconstruction module 24, configured to reconstruct a point cloud by using the two-dimensional projection plane structure.

The decoding apparatus provided in this embodiment can implement the decoding method described in embodiment 3. The detailed process is not described herein again.

The foregoing descriptions are further detailed descriptions of the present application with reference to specific preferred embodiments, and it cannot be construed that the specific implementation of the present application is merely limited to these descriptions. For those of ordinary skill in the technical field of the present application, without departing from the concept of the present application, some simple deductions or replacements can be further made and should fall within the protection scope of the present application.

1. A point cloud encoding method, comprising:
acquiring raw point cloud data;
performing two-dimensional regularized plane projection on the raw point cloud data to obtain a two-dimensional projection plane structure;
obtaining one or more pieces of two-dimensional graphic information comprising a coordinate conversion error information graph, based on the two-dimensional projection plane structure; and
encoding the coordinate conversion error information graph to obtain a coordinate conversion error information bit stream.

2-3. (canceled)

4. The point cloud encoding method according to claim 1, wherein the encoding comprises:
predicting pixels in the coordinate conversion error information graph based on a placeholder information graph, a depth information graph, and a projection residual information graph to obtain a prediction residual of a coordinate conversion error; and
encoding the prediction residual of the coordinate conversion error to obtain the coordinate conversion error information bit stream.

5. The point cloud encoding method according to claim 4, wherein the predicting the pixels in the coordinate conversion error information graph based on the placeholder information graph, the depth information graph, and the projection residual information graph to obtain the prediction residual of the coordinate conversion error comprises:
traversing the pixels in the coordinate conversion error information graph according to a scanning order, and identifying encoded and decoded non-empty pixels in an area adjacent to a current non-empty pixel based on the placeholder information graph;
establishing a relationship between depth information and coordinate conversion error information by using the encoded and decoded non-empty pixels, and establishing a relationship between projection residual information and coordinate conversion error information by using the encoded and decoded non-empty pixels;
estimating coordinate conversion error information corresponding to a current pixel based on the relationship between depth information and coordinate conversion error information and the relationship between projection residual information and coordinate conversion error information, to obtain an estimated value of the coordinate conversion error of the current pixel; and
using the estimated value as a predicted value of the coordinate conversion error of the current pixel to obtain a prediction residual of the coordinate conversion error of the current pixel.

6. The point cloud encoding method according to claim 1, wherein the encoding comprises:
predicting pixels in the coordinate conversion error information graph based on one or more information graphs among a placeholder information graph, a depth information graph, and a projection residual information graph to obtain a prediction residual of a coordinate conversion error; and
encoding the prediction residual of the coordinate conversion error to obtain the coordinate conversion error information bit stream.

7-10. (canceled)

11. The point cloud encoding method according to claim 1, wherein the encoding comprises:
predicting pixels in the coordinate conversion error information graph based on reconstructed coordinate conversion error information of encoded and decoded pixels to obtain a prediction residual of a coordinate conversion error; and
encoding the prediction residual of the coordinate conversion error to obtain the coordinate conversion error information bit stream.

12. A point cloud encoding apparatus, comprising:
a processor configured to:
acquire raw point cloud data;
perform two-dimensional regularized plane projection on the raw point cloud data to obtain a two-dimensional projection plane structure;
obtain one or more pieces of two-dimensional graphic information comprising a coordinate conversion error information graph, based on the two-dimensional projection plane structure; and
encode the coordinate conversion error information graph to obtain a coordinate conversion error information bit stream.

13. The point cloud encoding apparatus according to claim 12, wherein the encoding comprises:
predicting pixels in the coordinate conversion error information graph based on a placeholder information graph, a depth information graph, and a projection residual information graph to obtain a prediction residual of a coordinate conversion error; and
encoding the prediction residual of the coordinate conversion error to obtain the coordinate conversion error information bit stream.

14. The point cloud encoding apparatus according to claim 13, wherein the predicting the pixels in the coordinate conversion error information graph based on the placeholder information graph, the depth information graph, and the projection residual information graph to obtain the prediction residual of the coordinate conversion error comprises:
traversing the pixels in the coordinate conversion error information graph according to a scanning order, and identifying encoded and decoded non-empty pixels in an area adjacent to a current non-empty pixel based on the placeholder information graph;
establishing a relationship between depth information and coordinate conversion error information by using the encoded and decoded non-empty pixels, and establishing a relationship between projection residual information and coordinate conversion error information by using the encoded and decoded non-empty pixels;
estimating coordinate conversion error information corresponding to a current pixel based on the relationship between depth information and coordinate conversion error information and the relationship between projection residual information and coordinate conversion error information, to obtain an estimated value of the coordinate conversion error of the current pixel; and
using the estimated value as a predicted value of the coordinate conversion error of the current pixel to obtain a prediction residual of the coordinate conversion error of the current pixel.

15. The point cloud encoding apparatus according to claim 12, wherein the encoding comprises:
predicting pixels in the coordinate conversion error information graph based on one or more information graphs among a placeholder information graph, a depth information graph, and a projection residual information graph to obtain a prediction residual of a coordinate conversion error; and
encoding the prediction residual of the coordinate conversion error to obtain the coordinate conversion error information bit stream.

16. The point cloud encoding apparatus according to claim 12, wherein the encoding comprises:
predicting pixels in the coordinate conversion error information graph based on reconstructed coordinate conversion error information of encoded and decoded pixels to obtain a prediction residual of a coordinate conversion error; and
encoding the prediction residual of the coordinate conversion error to obtain the coordinate conversion error information bit stream.

17. A point cloud decoding method, comprising:
acquiring bit stream information;
decoding the bit stream information using entropy decoding to obtain parsed data;
reconstructing one or more pieces of two-dimensional graphic information based on the parsed data, wherein the one or more pieces of two-dimensional graphic information comprises a prediction residual of coordinate conversion error information;
obtaining a two-dimensional projection plane structure based on the one or more pieces of two-dimensional graphic information; and
reconstructing a point cloud by using the two-dimensional projection plane structure.

18. The point cloud decoding method according to claim 17, wherein the reconstructing the one or more pieces of two-dimensional graphic information based on the parsed data comprises:
reconstructing a coordinate conversion error information graph based on the prediction residual of a coordinate conversion error information graph in the parsed data to obtain a reconstructed coordinate conversion error information graph.

19. The point cloud decoding method according to claim 17, wherein the obtaining the two-dimensional projection plane structure based on the one or more pieces of two-dimensional graphic information comprises:
obtaining the coordinate conversion error information of each non-empty pixel in the two-dimensional projection plane structure; and
obtaining a reconstructed two-dimensional projection plane structure based on the coordinate conversion error information.

20. The point cloud decoding method according to claim 17, wherein the reconstructing the point cloud by using the two-dimensional projection plane structure comprises:
reconstructing a spatial point for each non-empty pixel in the two-dimensional projection plane structure; and
obtaining a reconstructed point cloud based on the spatial point for each non-empty pixel in the two-dimensional projection plane structure.
